(19) United States
(12) Patent Application Publication
(10) Pub. No.: US 2009/0087719 A1
(43) Pub. Date: Apr. 2, 2009

(54) NOISE ELIMINATOR FOR FUEL CELL

(76) Inventors: Toshiyuki Kondo, Aichi-ken (JP); Kiyoshi Yoshizumi, Aichi-ken (JP); Hideaki Taniguchi, Aichi-ken (JP); Toshihiro Shibata, Aichi-ken (JP); Kazunori Yanagihara, Aichi-ken (JP)

Correspondence Address: KENYON & KENYON LLP, 1500 K STREET N.W., SUITE 700, WASHINGTON, DC, 20005, US

(21) Appl. No.: 12/297,345

(22) PCT Filed: May 9, 2007
(86) PCT No.: PCT/JP2007/059994

§ 371 Date: Oct. 16, 2008

(30) Foreign Application Priority Data
May 19, 2006 (JP) 2006-139707

(51) Int. Cl. H01M 2/02

(52) U.S. Cl. 429/34

(57) ABSTRACT

A noise eliminator for a fuel cell has a noise elimination chamber that is filled with a noise elimination material, and also has discharge gas flow piping penetrating the noise elimination chamber and having holes in the peripheral wall of the piping and through which gas charged from the fuel cell flows. An electrically conductive material is added to the noise elimination material. The construction suppresses electrostatic charging even if discharge gas flows in the discharge gas flow piping.

### TECHNICAL FIELD

The present invention relates to a noise eliminator for a fuel cell, which eliminates noise of off-gas generated when the off-gas is discharged from a fuel cell, and more particularly relates to a noise eliminator for a fuel gas which suppresses electrostatic charging.

### BACKGROUND ART

Conventionally, noise eliminators have been used for a fuel cell which eliminate noise of off-gas generated when the off-gas is discharged from a fuel cell which generates electric power by using a fuel gas such as hydrogen gas and so on. These type of noise eliminators for a fuel cell are disposed in piping (a discharge system) through which off-gas discharged from the fuel cell flows.

There are cases in which the off-gas of the fuel cell contains hydrogen gas which has been discharged without having been consumed as a fuel. Consequently, if any ignition sources exist in the vicinity of the discharge system, there is a possibility that the hydrogen gas contained in the off-gas would be ignited by means of the ignition sources.

JP 2005-69189 A discloses a technology of a noise eliminator for a fuel cell vehicle in which a mesh-type flame entering prevention member is attached on an exit port of a discharge pipe provided in the noise eliminator. This flame entering prevention member prevents flame from entering through the exit port of the discharge pipe.

Here, with the passage of gas (especially dried gas) through a noise eliminator for a fuel cell, static electricity is generated to electrically charge the noise eliminator. It is particularly likely that noise eliminators for a fuel cell, in which an electrically non-conductive noise elimination material such as glass wool and a nonwoven fabric made of a resin fiber is used, are electrically charged with the static electricity. Here, there may arise a problem that, when the static electricity thus accumulated is discharged, the discharged static electricity would allow the hydrogen gas or the like contained in the off-gas discharged from the fuel cell to ignite to burn.

### DISCLOSURE OF THE INVENTION

In accordance with an aspect of the present invention, there is provided a noise eliminator for a fuel cell including a noise elimination chamber that is filled with a noise elimination material, and discharge gas flow piping which penetrates through the noise elimination chamber and has holes in the peripheral wall thereof and through which gas discharged from the fuel cell flows, wherein an electrically conductive material is added to the noise elimination material.

### BRIEF DESCRIPTION OF THE DRAWINGS

These and other objects of the invention will be explained in the description below, in connection with the accompanying drawings, in which:

FIG. 1 is a diagram schematically showing a structure of a noise eliminator for a fuel cell according to an embodiment of the present invention;

FIG. 2 is a cross sectional view of the noise eliminator for a fuel cell shown in FIG. 1;

FIG. 3 is a diagram schematically showing a structure of a noise eliminator for a fuel cell according to another embodiment of the present invention;

FIG. 4 is a plan view of a partitioning conductor plate 22 provided in the noise eliminator for a fuel cell shown in FIG. 3;

FIG. 5 is a diagram schematically showing a structure of a noise eliminator for a fuel cell according to still another embodiment of the present invention;

FIG. 6 is a cross sectional view of the noise eliminator for a fuel cell taken along dashed line Y-Y in FIG. 5;

FIG. 7 is a diagram schematically showing a structure of a noise eliminator for a fuel cell according to still another embodiment of the present invention;

FIG. 8 is a diagram schematically showing a structure of a noise eliminator for a fuel cell according to still another embodiment of the present invention; and

FIG. 9 is a view for explaining the relationship of locations of a fuel cell and a noise eliminator for a fuel cell, in which FIG. 9(a) shows a state in which a noise eliminator for a fuel cell is disposed adjacent to a fuel cell, and FIG. 9(b) shows a state in which a fuel cell and a noise eliminator for a fuel cell are arranged with predetermined piping interposed therebetween.

### BEST MODE FOR CARRYING OUT THE INVENTION

Preferred embodiments of the present invention will be described with reference to the drawings.

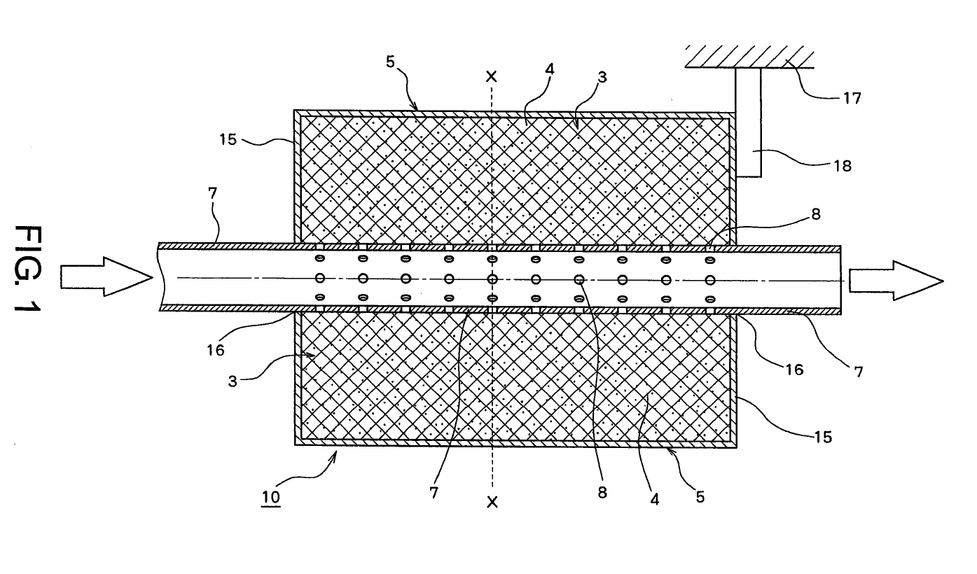

FIG. 1 is a view (a side sectional view) schematically showing a structure of a noise eliminator for a fuel cell 10 according to an embodiment of the present invention. The noise eliminator for a fuel cell 10 is for use in a fuel cell system including a fuel cell (not shown) which generates electric power by using hydrogen gas and oxidized gas (typically oxygen in the air). In this embodiment, the fuel cell system is an on-vehicle fuel cell system. The fuel cell includes an ion-conductive electrolyte membrane having electrodes formed on both surfaces. Hydrogen gas is supplied to the electrode on one surface of the electrolyte membrane and oxidized gas is supplied to the electrode on the other surface of the electrolyte membrane. The supplied gases react with each other in the electrodes and are consumed. However, not all the gases are consumed in the electrodes, and unconsumed gas is discharged as a discharge gas (i.e. off-gas) from the fuel cell through predetermined piping. The noise eliminator for a fuel cell 10 is used for eliminating discharging noise of the off-gas which is discharged from the fuel cell through the predetermined piping. The noise eliminator for a fuel cell 10 can be used for elimination of noise of the off-gas discharged from the electrode side to which hydrogen gas is supplied and also elimination of noise of the off-gas discharged from the electrode side to which oxidized gas (air) is supplied. The off-gas includes hydrogen gas and oxidized gas (oxygen) which has not been consumed in the electrodes, air (including oxygen, nitrogen, and so on), water (water vapor) generated due to the reaction, and so on.

The noise eliminator for a fuel cell 10 includes a noise elimination chamber 5 which is filled with a noise elimination material 3, and discharge gas flow piping 7 which penetrates the noise elimination chamber 5.

The noise elimination material 3 is a mixed material formed of an electrically non-conductive (insulating) material formed of a resin fiber such as polyester and so on and an electrically conductive material 4 such as a carbon fiber. The resin fiber which is used as an electrically non-conductive material may include, for example, an aramid fiber, a polyphenylene sulfide fiber, a polybenzoxazole fiber, a polybenzimidazole fiber, a polyetheretherketone fiber, a polyarylate fiber, a polyimide fiber, and so on. The mixture ratio (mass %) of the electrically conductive material 4 with respect to the electrically non-conductive material is preferably 0.01 mass % to 2.0 mass %. It is preferable that the electrically conductive material 4 is mixed uniformly with respect to the electrically non-conductive material. The volume resistivity (Ωcm) of the noise elimination material 3 is set to 10⁶ Ωcm or smaller. With the volume resistivity exceeds 10⁶ Ωcm, the effect of suppressing the electrostatic charging is reduced. The noise elimination material 3 is a porous material and may be in the known form such as a non-woven fabric, web, felt, and so on. The electrically conductive material may be in various forms including a fibrous form, a powdered form (filler), and so on. A preferable combination of the electrically non-conductive material and the electrically conductive material 4 in the noise elimination material 3 is a combination of a glass fiber and a carbon fiber, for example. The carbon fiber is easy to mix in the glass fiber in a uniform manner. The electrically non-conductive material and the electrically conductive material 4 may be bonded using a resin.

The noise elimination chamber 5 is filled with the noise elimination material 3. The noise elimination chamber 5 is a substantially cylindrical vessel (casing) and is formed of an electrically conductive material which is a metal material such as aluminum, stainless steel, and so on. The inner surface of the noise elimination chamber 5 is in contact with the noise elimination material 3. In other words, the surface of the noise elimination material 3 is covered with the electrically conductive material. In the noise elimination chamber 5 having a substantially cylindrical shape, each of end surfaces having a substantially disk-like shape includes an insertion hole 16 through which the discharge gas flow piping passes.

The discharge gas flow piping 7 is formed of an electrically conductive material which is, for example, a metal material such as aluminum and stainless steel. The discharge gas flow piping 7 is piping having a substantially cylindrical shape, through which gas discharged from the fuel cell flows. The discharge gas flows through the discharge gas flow piping 7 in the direction indicated by an arrow in FIG. 1. The discharge gas flow piping 7 has a plurality of holes 8 formed in the peripheral wall thereof. These holes 8 are arranged at predetermined intervals along the axial direction of the discharge gas flow piping 7 (the flowing direction of the discharge gas). These holes 8 are similarly arranged at predetermined intervals along the circumferential direction of the discharge gas flow piping 7. The discharge gas flow piping 7 is inserted through the insertion holes 16 formed on the end surfaces 15 of the noise elimination chamber 5 so as to penetrate the noise elimination chamber 5 which is filled with the noise elimination material 3. Here, the outer surface of the peripheral wall of the discharge gas flow piping 7 is coupled and fixed to the peripheral edge portion of the insertion holes by welding or the like in such a manner that no space exists between them. The discharge gas flow piping 7 is connected and fixed to predetermined piping (not shown) through which the gas (off-gas) discharged from the fuel cell flows.

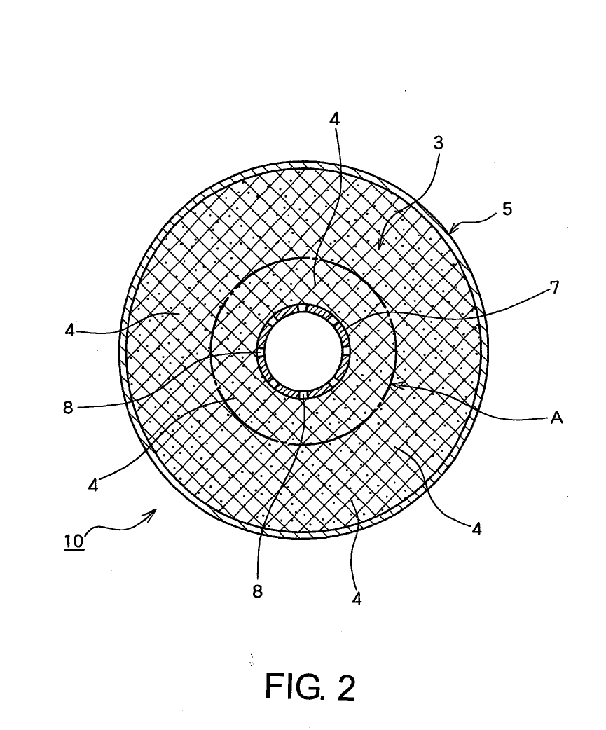

FIG. 2 is a cross sectional view of the noise eliminator for a fuel cell 10 taken along dotted line X-X in FIG. 1. FIG. 2 shows the state in which the peripheral wall of the discharge gas flow piping 7 is covered with the noise elimination material 3. The noise elimination material 3 is in contact with the outer surface of the discharge gas flow piping 7 and the inner surface of the noise elimination chamber 5. In one embodiment, the noise elimination material 3 provided at least in the region near the peripheral wall of the discharged bas flow piping 7 (the region A, for example) may include the electrically conductive material 4.

As shown in FIG. 1, the noise eliminator for a fuel cell 10 is grounded (earthed) to a vehicle body 17 via an electrical conductor member 18. The electrical conductor member 18 is coupled and fixed to the end surface 15 of the noise elimination chamber 5 and the vehicle body 17.

In the noise eliminator for a fuel cell 10, when the discharge gas passes through the interior of the discharge gas flow piping 7, a portion of the discharge gas transmits through the holes 8 formed in the peripheral wall of the discharge gas flow piping 7 and is diffused into the noise elimination material 3 in the noise elimination chamber 5. Thus, the noise eliminator for a fuel cell 10 diffuses the discharge gas into the noise elimination chamber 5 to thereby reduce the discharging noise. Here, when the discharge gas passes through the discharge gas flow piping 7, static electricity is generated in the noise eliminator for a fuel cell 10 due to friction between the discharge gas and the discharge gas flow piping 7. It is especially highly likely that the static electricity is generated when, under the condition that a vehicle is actuated at a low temperature and so on, dried off-gas with a low water content is discharged from a fuel cell and flows through the discharge gas flow piping 7. In the noise eliminator for a fuel cell 10, static electricity is likely to be generated in the noise elimination material 3 which includes an electrically non-conductive material such as glass fiber. In particular, static electricity is highly likely to be generated in a portion of the noise elimination material 3 close to the discharge gas flow piping 7 (i.e. in the vicinity of the peripheral wall or peripheral edge of the discharge gas flow piping 7; the region A shown in FIG. 2). According to the present embodiment, however, the noise elimination material 3 of the noise eliminator for a fuel cell 10 includes a predetermined amount of the electrically conductive material 4. At least, the electrically conductive material 4 is contained in the noise elimination material 3 in the region close to the discharge gas flow piping 7 (i.e. in the vicinity of the peripheral wall or peripheral edge of the discharge gas flow piping 7) in which static electricity is most likely to be generated. Accordingly, even if static electricity is generated in the noise elimination material 3, the static electricity is eliminated immediately by the electrically conductive material 4. Here, because the noise eliminator for a fuel cell 10 is grounded to the vehicle body 17, even if static electricity is generated in the noise elimination material 3, the static electricity can be routed away from the noise elimination material 3 to the noise elimination chamber 5, then to the electric conductor member 18, and further to the vehicle body 17 in a reliable manner.

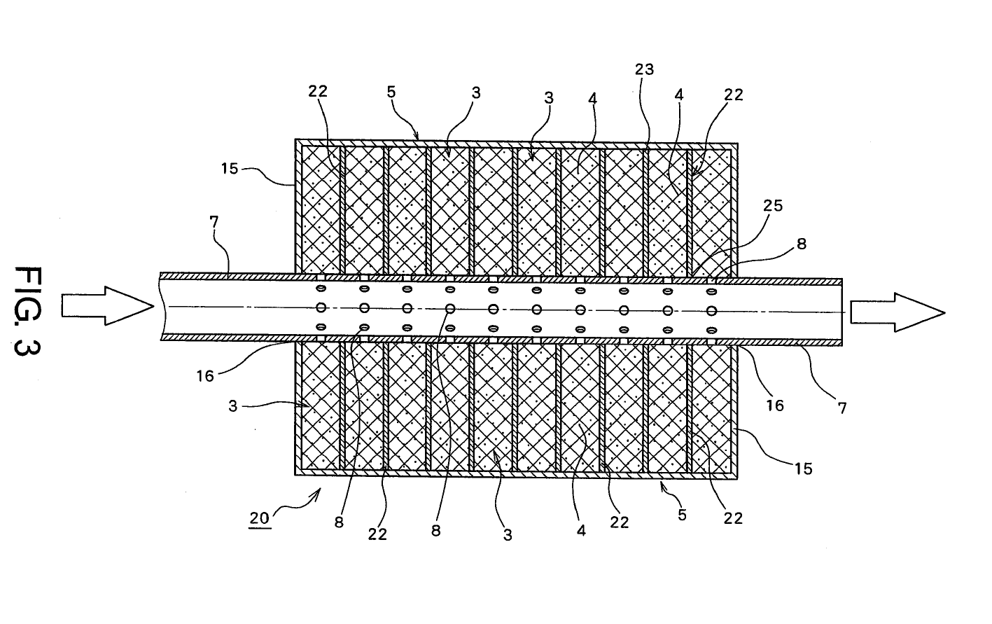

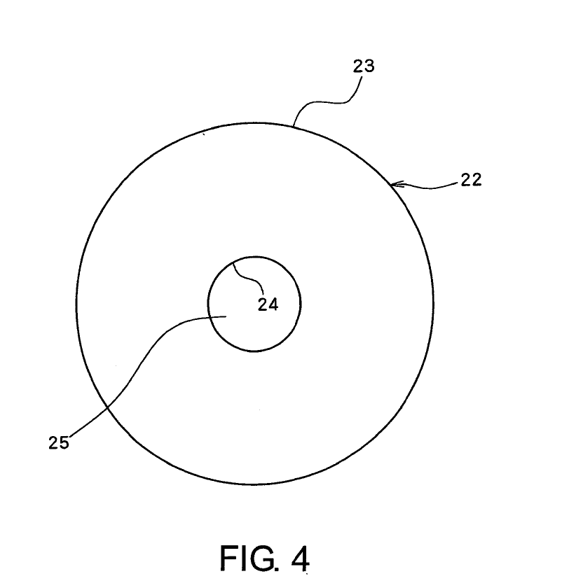

Another embodiment of the preset invention will be described with reference to FIGS. 3 and 4. FIG. 3 is a view (side sectional view) schematically showing a structure of a noise eliminator for a fuel cell 20 according to another embodiment. The noise eliminator for a fuel cell 20 includes partitioning conductor plates 22 for partitioning the noise elimination material 3 at predetermined intervals within the noise elimination chamber 5. FIG. 4 is a plan view of the partitioning conductor plate 22. In FIGS. 3 and 4, elements which are the same as those of the noise eliminator for a fuel cell 10 according to the above-described embodiment are designated by the same numerals. The partitioning conductor plate 22 is formed of an electrically conductive material such as aluminum and stainless steel. The partitioning conductor plate 22 is a substantially disk-like plate having an insertion hole 25 in the center thereof, through which the discharge gas flow piping 7 is inserted. The partitioning conductor plates 22 are arranged in the noise elimination chamber 5 at predetermined intervals along the axial direction of the discharge gas flow piping 7. A peripheral edge portion 24 of the insertion hole 25 in each partitioning conductor plate 22 is coupled and fixed to the surface of the peripheral wall of the discharge gas flow piping 7. Further, the outer peripheral edge portion 23 of the partitioning conductor plate 22 is coupled and fixed to the inner surface of the noise elimination chamber 5. The space between the adjacent partitioning conductor plates 22 is filled with the noise elimination material 3 with no space being left therebetween. In this embodiment, similar to the above-described embodiment, the electrically conductive material 4 is added to the noise elimination material 3.

In the noise eliminator for a fuel cell 20, when off-gas passes through the discharge gas flow piping 7, static electricity is generated due to friction between the discharge gas flow piping 7 and the off-gas. Particularly, static electricity is generated in the noise elimination material 3. However, the static electricity which is generated is eliminated by the electrically conductive material 4 (i.e. charging is prevented). Further, the static electricity which is generated is allowed to escape into the noise elimination chamber 5 through the partitioning conductive plates 22. Here, if the noise elimination chamber 5 is grounded to the vehicle body, the static electricity can be routed further into the vehicle body. While the electrically conductive material 4 is added to the noise elimination material 3 in the noise eliminator for a fuel cell 20 according to this embodiment, the electrically conductive material need not be included in the noise elimination material 3 in other modification examples, because sufficient prevention of charging can be achieved with only the partitioning conductor plates 22. In such modification examples, it is possible to prevent (suppress) electrostatic charging without using an expensive material such as carbon fiber.

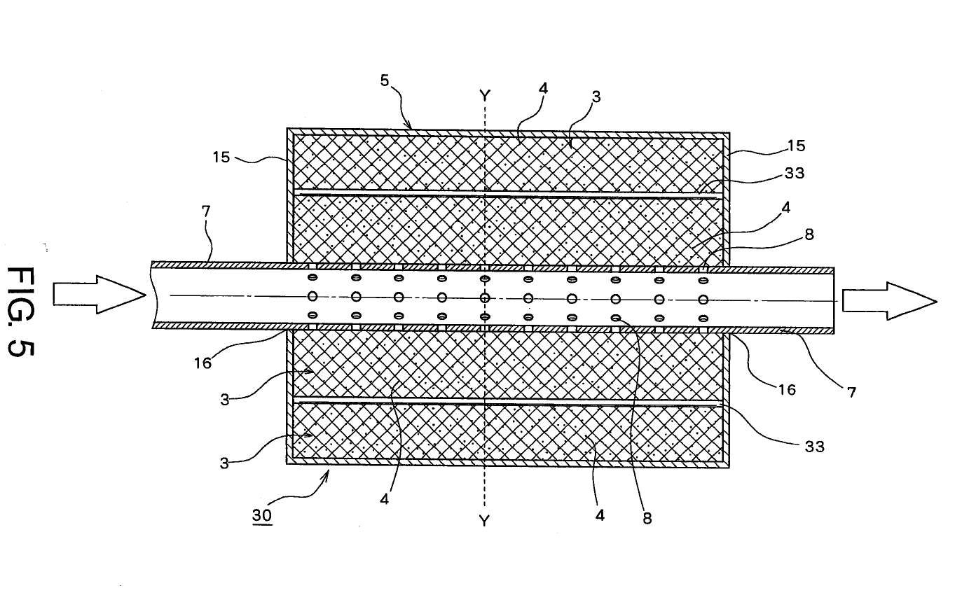

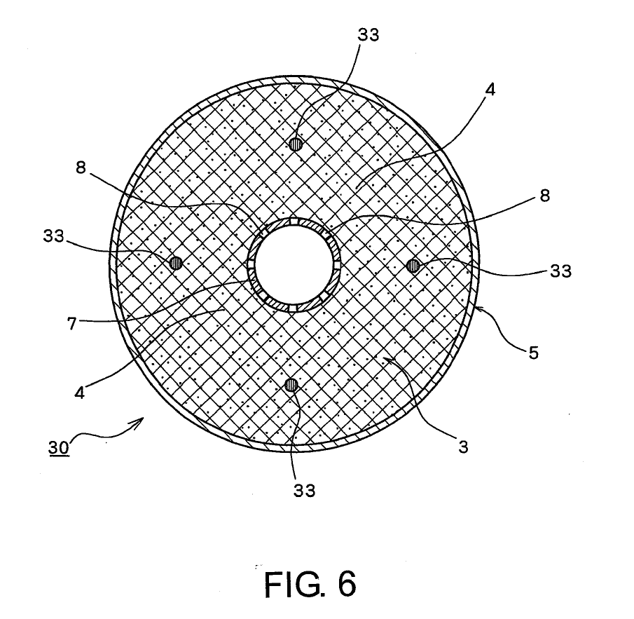

A still further embodiment will be further described with reference to FIGS. 5 and 6. FIG. 5 is a view (side sectional view) schematically showing a structure of a noise eliminator for a fuel cell 30 according to a still another embodiment of the present invention. FIG. 6 is a sectional view of the noise eliminator for a fuel cell 30 taken along dotted line Y-Y in FIG. 5. It should be noted that in FIGS. 5 and 6, elements which are the same as those of the noise eliminator for a cell 10 according to the above-described embodiment are designated by the same numerals. The noise eliminator for a fuel cell 30 includes conductor rods 33 penetrating the noise elimination chamber 5 which is filled with the noise elimination material 3. The conductor rod 33 is formed of a member (e.g. stainless steel) which is similar to that of the noise elimination chamber 5. Both ends of the conductor rod 33 are coupled and fixed to the respective end surfaces 15 of the noise elimination chamber 5. The conductor rod penetrates the noise elimination material 3. Here, the electrically conductive material 4 is included in the noise elimination material 3. It is preferable that a plurality of conductor rods 33 are provided in the noise eliminator for a fuel cell 30.

In the noise eliminator for a fuel cell 30, as in the above examples, when the off-gas passes through the discharge gas flow piping 7, static electricity is generated, particularly in the noise elimination material 3, due to the friction between the off-gas and the discharge gas flow piping 7. However, as the static electricity thus generated is eliminated by the electrically conductive material 4, electrostatic charging can be prevented. In addition, the static electricity which is generated is allowed to escape into the noise elimination chamber 5 through the conductor rods 33. If the noise elimination chamber 5 is grounded to the vehicle body, the static electricity can be further routed into the vehicle body. While the electrically conductive material 4 is added to the noise elimination material 3 in the noise eliminator for a fuel cell 30 according to the present embodiment, the electrically conductive material 4 may not be included in the noise elimination material 3 in other modification examples, because sufficient prevention of electrostatic charging can be achieved only with the conductor rods 33. In this modification example, electrostatic charging can be prevented (suppressed) without the need to use an expensive material such as carbon fiber.

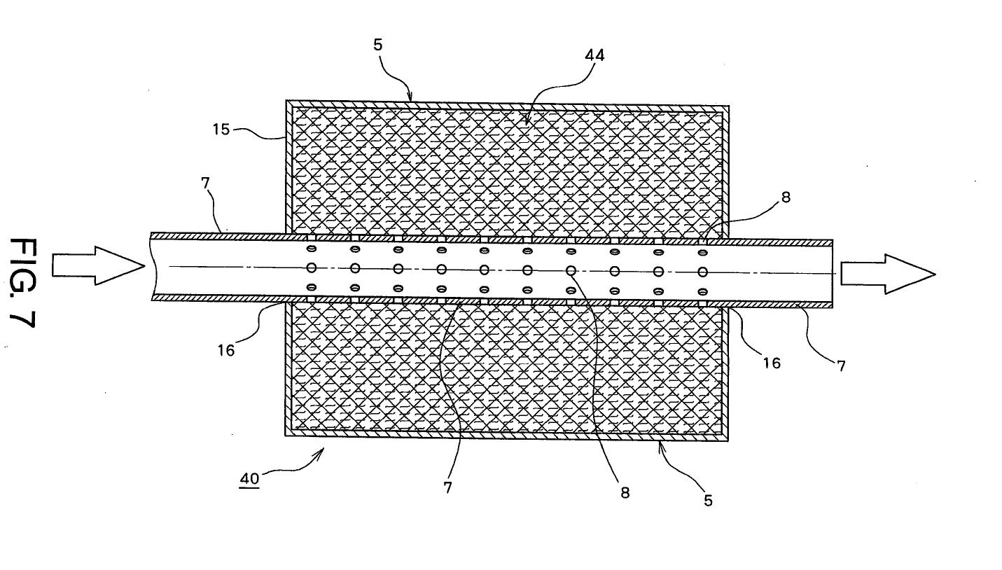

A still further embodiment of the present invention will be described with reference to FIG. 7. FIG. 7 is a view (side sectional view) schematically showing a structure of a noise eliminator for a fuel cell 40 according to this embodiment. In FIG. 7, elements which are the same as those of the noise eliminator for a fuel cell 10 according to the above embodiment are designated by the same numerals. In the noise eliminator for a fuel cell 40, the noise elimination chamber 5 is filled with a porous noise elimination material 44 having a hydrophilic coating applied on the surface thereof. The noise elimination material 44 is manufactured, for example, by applying coating of a hydrophilic resin or the like to an electrically non-conductive material such as a glass fiber which is used in the above-described noise elimination material 4. Here, the noise elimination material 44 includes hydrophilic coating which will not impair the noise canceling function on the surface thereof.

In the noise eliminator for a fuel cell 40, when the off-gas passes through the discharge gas flow piping 7, a water content contained in the off-gas is adsorbed by the noise elimination material 44 which retains an appropriate degree of water content. As such, even if static electricity is generated in the noise elimination material 44 due to the passage of the off-gas through the discharge gas flow piping 7, the static electricity which is generated is eliminated by the water.

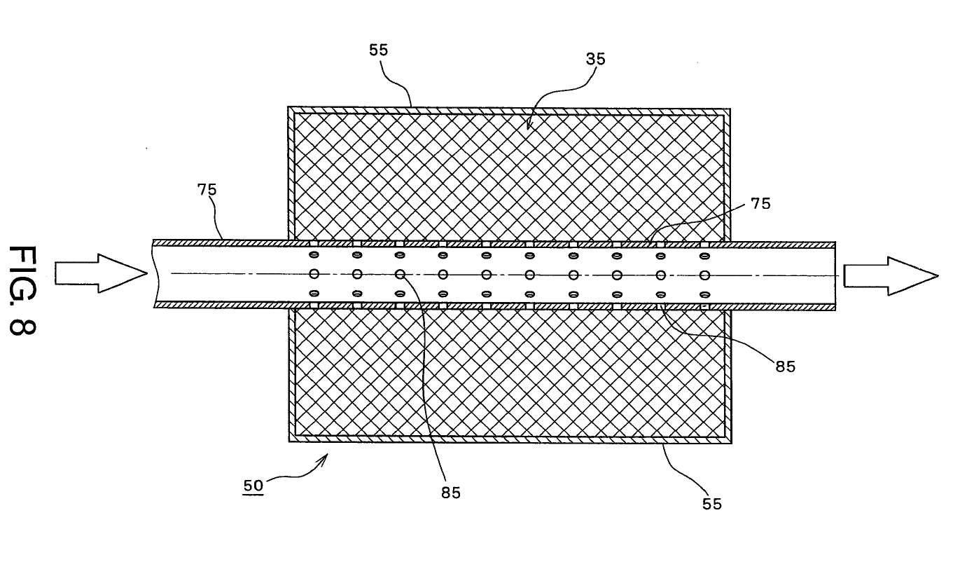

A still another embodiment will be described with reference to FIG. 8, which is a view (side sectional view) schematically showing a noise eliminator for a fuel cell 50. In the noise eliminator for a fuel cell 50, discharge gas flow piping 75 and a noise elimination chamber 55 are formed of an electrically non-conductive material such as a resin. The noise elimination chamber 55 is filled with a noise elimination material 35 which is formed of an electrically non-conductive material such as a glass fiber. The discharge gas flow piping 75 includes a plurality of holes 85 formed on the peripheral wall thereof. In the noise eliminator for a fuel cell 50, when the off-gas passes through the discharge gas flow piping 75, static electricity is generated, and the noise elimination material 35 is charged. However, because no electrically conductive elements are present around the noise eliminator for a fuel cell 50, discharge of the static electricity which is accumulated can be suppressed. Accordingly, even if hydrogen gas or the like passes through the discharge gas flow piping 75, generation of an ignition source which would allow the hydrogen gas or the like to ignite can be suppressed.

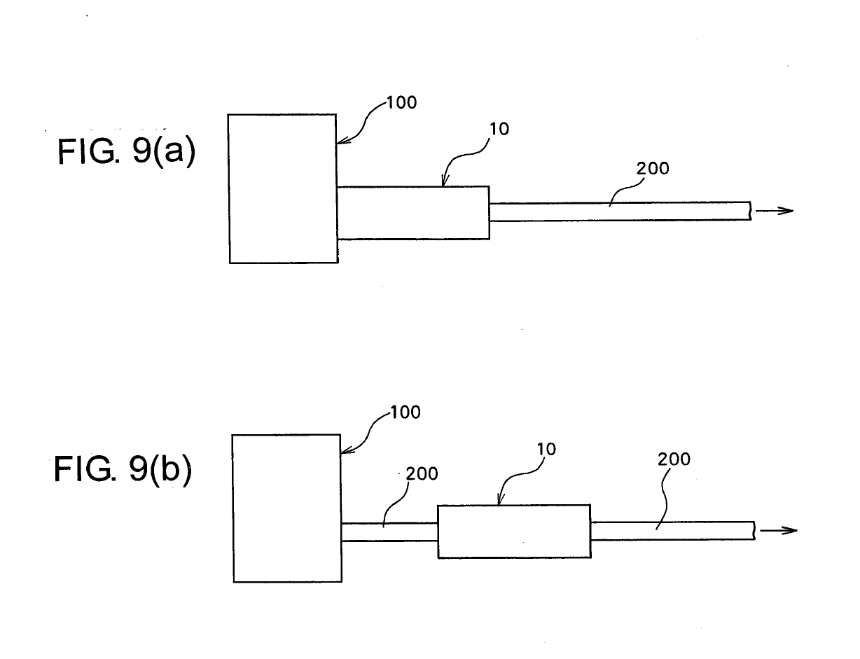

With reference to FIG. 9, a location at which the noise eliminator for a fuel cell 10 is disposed will be described. In FIG. 9(a), the noise eliminator 10 directly communicates with a fuel cell 100. Specifically, an off-gas discharge port (not shown) of the fuel cell 100 is directly communicated with the discharge gas flow piping 7 of the noise eliminator 10. Predetermined piping 200 is communicated with the discharge side of the noise eliminator 10. The off-gas flows in the direction indicated by an arrow in FIG. 9.

Here, the off-gas discharged from the fuel cell 100 while the fuel cell is generating electric power retains a certain degree of temperature (a heat quantity). As such, the off-gas is discharged in a state in which the off-gas is heated by the fuel cell 100. If the temperature of the off-gas is high, the amount of water content in the off-gas is increased. Accordingly, in light of prevention of static electricity, it is preferable that the temperature of the off-gas is reasonably high. When the noise eliminator for a fuel cell 10 is directly communicated with the fuel cell 100 as shown in FIG. 9(a), the noise eliminator for a fuel cell 10 eliminates noise of the off-gas which is being heated by the fuel cell 100. With this structure, it is possible to prevent the off-gas discharged from the fuel cell 100 from being cooled by an intervening piping or the like and losing heat and water content. Consequently, generation of static electricity can be suppressed to thereby reduce the amount of charging. Here, the noise eliminator for a fuel cell 10 can make full use of the charging prevention function even if the noise eliminator 10 and the fuel cell 100 are disposed with a certain interval therebetween as shown in FIG. 9(b).

Further, the noise eliminator for a fuel cell may be used for eliminating noise generated by a stationary fuel cell which is intended for home use, and so on.

1. A noise eliminator for a fuel cell, comprising:
a noise elimination chamber that is filled with a noise elimination material; and
discharge gas flow piping penetrating the noise elimination chamber and having a plurality of holes in a peripheral wall thereof, through which gas discharged from the fuel cell flows,
wherein the noise elimination material is formed of a fibrous electrically non-conductive material, and a fibrous electrically conductive material is added to the noise elimination material.

2. The noise eliminator for a fuel call according to claim 1, wherein
the electrically conductive material is added at least to the noise elimination material provided around a peripheral edge of the discharge gas flow piping.

3. The noise eliminator for a fuel cell according to claim 1, wherein
the electrically conductive material is carbon fiber.

4. The noise eliminator for a fuel cell according to claim 1, wherein
partitioning conductor plates are disposed in the noise elimination chamber for partitioning the noise elimination material at predetermined intervals.

5. The noise eliminator for a fuel cell according to claim 1, wherein
a conductor rod penetrating the noise elimination material is inserted in the noise elimination chamber.

6. The noise eliminator for a fuel cell according to claim 1, wherein
hydrophilic coating is applied to the noise elimination material.

7. The noise eliminator for a fuel cell according to claim 1, wherein
a volume resistivity of the noise elimination material is 10⁶ Ωcm or less.

8. The noise eliminator for a fuel cell according to claim 1, wherein
the noise elimination chamber is grounded.

9. The noise eliminator for a fuel cell according to claim 1, wherein
the noise eliminator for a fuel cell is disposed adjacent to a gas discharge port of the fuel cell.

10. The noise eliminator for a fuel cell according to claim 1, wherein
the noise eliminator for a fuel cell is used for a fuel cell which generates electric power by electrochemical reaction of hydrogen gas and oxidized gas.
